(19) United States
(12) Patent Application Publication
(10) Pub. No.: US 2010/0018408 A1
(43) Pub. Date: Jan. 28, 2010

(54) BREW BASKET ASSEMBLY AND BREWER

(76) Inventor: Zbigniew G. Lassota, Long Grove, IL (US)

Correspondence Address: James W. Potthast;Potthast & Associates, 10606 Deerpath Road, Woodstock, IL, 60098, US

(21) Appl. No.: 12/251,165

(22) Filed: Oct. 14, 2008

Related U.S. Application Data
(63) Continuation-in-part of application No. 11/050,521, filed on Feb. 3, 2005.
(60) Provisional application No. 61/000,089, filed on Oct. 23, 2007.
(60) Provisional application No. 60/542,759, filed on Feb. 6, 2004.

(51) Int. Cl. A47J 31/06

(52) U.S. Cl. 99/323

(57) ABSTRACT

A brew basket assembly 10 with an outer protective basket made of insulating plastic (12) and an inner basket made of stainless steel (14) nestled within the outer protective basket (12) with a drain hole (30) located opposite an open outlet (20). A removable wire brew basket (32) is supported by four support members (31) at the inside surface of the inner bottom (26), and a flow valve (34) is protectively mounted to the inner basket (14) between the open outlet (20) and the drain hole (30) for selectively restricting the drain hole (30) to control a rate of flow of beverage though the drain hole (30) and the open outlet (20). The outer basket insulates the hot beverage within the inner basket to reduce the risk of burning any users who may touch the outside of the brew basket, and the flow valve is adjusted for different rates when different beverages, such as tea and coffee, require different rates for optimum brewing.

### CROSS-REFERENCE TO RELATED APPLICATIONS

This application claims the benefit under 35 U.S.C. 119(e) of provisional patent application No. 61/000,089 of the present inventor filed Oct. 23, 2007, and entitled “Brew Basket Assembly and Brewing Method Employing Same”, and is a continuation-in-part of, and claims the benefit under, 35 U.S.C. 120 of U.S. application Ser. No. 11/050,521 filed Feb. 3, 2005, which, in turn, claims the benefit of U.S. Provisional patent application Ser. No. 60/542,759 filed Feb. 6, 2004.

### BACKGROUND OF THE INVENTION

1. Field of the Invention

This invention generally relates to beverage brewing and, more particularly, to a brew basket assembly used with electric drip-type coffee brewers.

2. Discussion of the Prior Art

Electric beverage brewers of the type that have a source of hot water that is selectively passed though a dry beverage ingredient, such as ground coffee beans or tea leaves, held within a filter paper that, in turn, is held in a filter holder within a metal brew basket body are well known. The brew basket body is has an open top and a bottom with a drain hole. The hot water is slowly passed though the layer of ingredient to create freshly brewed beverage that passes though the filter paper and out of the drain hole. The hot beverage passes directly from the drain hole into an inlet of an insulated dispenser. At the end of the brew cycle, the filled insulate dispenser may be removed to a remote serving location, and another empty insulated dispenser is moved to the brewing position beneath the brew basket to enable the commencement of another brew cycle.

Before a new brew basket can commence, the brew basket is removed from beneath the source of hot water to enable removal of the spent ingredient from the prior brew cycle and the supporting filter paper from the open top of the brew basket and a new filter supporting a preselected quantity of unused dry beverage ingredient is installed into the brew basket, and the brew basket is returned to an operative position beneath the hot water source. Alternatively, if the brew basket may be separated from the brewer, a new brew basket with a new load of ingredient is substituted for the brew basket used during the prior brew cycle. In some brewing systems of high volume, the brew basket is a slidably attached drawer-like member to the brewer housing and is not normally separated from the housing.

For further details of the types of brewers to which the present invention generally relates, reference should be made to the following United States patents of the present inventor, all of which are hereby incorporated by reference: U.S. Pat. No. 5,000,082 issued Mar. 19, 1991 for “Beverage Maker and Method of Making Beverage”; U.S. Pat. No. 5,331,885 issued Jul. 26, 1994 for “Semiautomatic Beverage Maker and Method”; U.S. Pat. No. 5,943,944 issued Aug. 31, 1999; U.S. Pat. No. 6,706,300 issued Mar. 16, 2004 for “Brewing System with Movable Brew Basket Mounting Apparatus and Method” and U.S. Pat. No. 6,499,628 issued Dec. 31, 2002 for “Insulated Urn with Heat Retentive Closures and Method”.

In all brewers of the type that do not use heaters to maintain the beverage temperature within the dispenser the temperature gradually declines. The temperature of the beverage as it enters the dispenser is the hottest temperature that the beverage will thereafter reach. In order to reduce heat loss through the inlet during the filling of the dispenser, it is known to make the dispenser inlet no larger than necessary to accommodate the maximum beverage flow rate from the drain hole without the beverage backing up and to locate the dispenser inlet closely adjacent to the drain hole. It is also known to reduce heat loss by passing the beverage directly to the bottom of the dispenser through a down tube and to pass the beverage to the inlet of the down tube through an insulated funnel mounted within the top cover of the dispenser. Despite the insulation of the dispenser, the temperature of the beverage gradually declines due to removal of beverage during serving, heat radiation and heat conduction through the insulated top cover and walls of the dispenser.

Eventually the temperature of the beverage will reach the ambient temperature of the location of the dispenser, but long before then, the temperature passes through a preselected minimum serving temperature. When this occurs, in commercial freshly brewed coffee or tea serving establishments, the remaining beverage is no longer served but is dumped and thus wasted.

It is therefore desired to extend the length of time that it takes for the beverage temperature to decline from maximum temperature to the minimum serving temperature. This time duration is directly related to the initial temperature of the beverage when it is first added to the dispenser. This initial composite temperature of the beverage within the dispenser is directly related to the initial temperature of the hot water when it is first added to the beverage. This initial temperature can be controlled to a degree by controlling the initial temperature of the hot water that is added to the beverage ingredient in the brew basket, but this temperature cannot be made hotter than the boiling point of the water. However, the optimal flavor results are generally obtained when the hot water is several degrees beneath the boiling temperature of the water.

Regardless of the temperature of the hot water, the inventor has noted that there is significant heat loss within the brew basket due to conduction of heat though the side walls and bottom of the metal brew baskets in addition to radiation. The longer the time duration of the brew cycle including the dispense period as well as the drip period and any pre-wetting period, the greater is the reduction in temperature, but there are limits to how short the brew cycle can be made, and different preselected, brew cycle times have been determined for different quantities and different types of ingredient to obtain optimal flavor and other beverage ingredient extraction, and it is therefore undesirable to vary from these time periods.

Because of the heat conduction through the walls and bottom of the metal brew basket, the brew basket becomes heated to a relatively high temperature. This is due to the high level of thermal conduction of the stainless steel that is generally required for purposes of durability, inertness and hygiene and to obtain FDA approval for contact with food in a commercial brewer. After completion of the brew cycle, except for a small residual amount still held by the spent ingredient, all the hot water has passed from the brew basket and the brew basket temperature will begin to decline. Eventually, the brew basket will reach a temperature that is comfortable to the touch and, more importantly, which will not cause burn injury, if touched.

The inventor has noted, however, that in commercial operations, it is often required to rapidly perform successive brew cycles beginning one brew cycle as soon as a prior brew cycle is completed. This requires handling of the brew basket at the end of each brew cycle before there has been sufficient cooling time to safely handle the hot brew basket without risk of pain or burn injury. Even without serious burn injury, the brew basket may be dropped during handling due to the heat pain and the hot wet ingredient spilled. Also, when encountering such risks, employees may be reluctant to rapidly cycle the brewer even when required by demand for high volume production of freshly brewed beverage, resulting in undesirably slow service.

Thus, the inventor has observed that there is a need for improvement in brewers, brewing methods and brew baskets that will overcome the safety and beverage-temperature maintenance problems noted above.

### SUMMARY OF THE INVENTION

It is therefore the object of the present invention to provide a brewer, a brew basket and method of brewing that overcomes the disadvantages of known brewers and brew baskets noted above

This objective is achieved, in part, by provision of a brew basket assembly, with an outer protective basket with an open top, a bottom with an open outlet spaced from the open top and a sidewall extending between the open top and the bottom, an inner basket with an inner open top, a inner bottom spaced from the inner open top and an inner wall extending between the inner top and the inner bottom, said inner basket being nestled within the outer protective basket and having a drain hole located opposite the open outlet, means for supporting a filter holder within the inner basket, and a flow valve protectively mounted to the inner basket between the open outlet and the drain hole for selectively restricting the drain hole to control a rate of flow of beverage though the drain hole and the open outlet.

Preferably, the outer protective basket is made from an insulating plastic material, the inner basket is made from stainless steel and there is an air gap between the inner wall of the inner basket and the sidewall of the outer protective basket. Also, a gap between the open top of the outer protective basket and the inner open top of the inner basket for receipt of bypass water that extends from the inner open top to the inner bottom. A peripheral support member resting on the bottom of the outer protective basket adjacent the sidewall supports the inner basket above the bottom of the outer basket.

In the preferred embodiment, the flow valve has a generally cylindrical body with a fluid passageway providing fluid communication from within the inner basket to without the inner basket through the drain hole and an adjustment member mounted to the cylindrical body for relative rotary movement to selectively restrict the fluid passageway to vary flow rate of beverage through the passageway. Preferably, the rotatably mounted adjustment member is accessible through the open outlet for manual engagement.

Achievement of the object of the invention is also partly obtained by providing in a brew basket assembly with an interior for holding beverage ingredient during the passage of water through the brew basket of an electric, drip-type, beverage brewer, having a basket with an open top, a bottom spaced from the open top, a wall extending between the top and the bottom and a drain hole in the bottom, a filter holder mounted within the basket, and a continuous flow rate adjustable, valve assembly mounted within the drain hole and having a movably mounted, manual adjustment member for manually selectively adjusting the flow rate of beverage through the flow valve and the drain hole during a brew cycle.

In the preferred embodiment, the valve assembly includes a valve body with a passageway extending between an inlet within the basket and an outlet located without the basket, means for fastening the valve body within the drain hole, and means for mounting the adjustment member to the valve body for relative rotary movement to selectively adjust the flow rate of beverage through the valve body.

### BRIEF DESCRIPTION OF THE DRAWINGS

The invention is described below with reference to the several figures of the drawings, in which:

FIG. 1 is a side view of an embodiment of brew basket of the present invention;

FIG. 2 is a front view of the brew basket of FIG. 1 but with the handle removed;

FIG. 3 is a plan view of the brew basket of FIG. 1; and

FIG. 4 is an enlarged portion of the bottom of the brew basket showing the adjustable drain hole valve;

FIG. 5 is a plan view of the drain hole valve shown in FIG. 5; and

FIG. 6 is a an exploded view of the adjustable drain hole valve.

### DETAILED DESCRIPTION

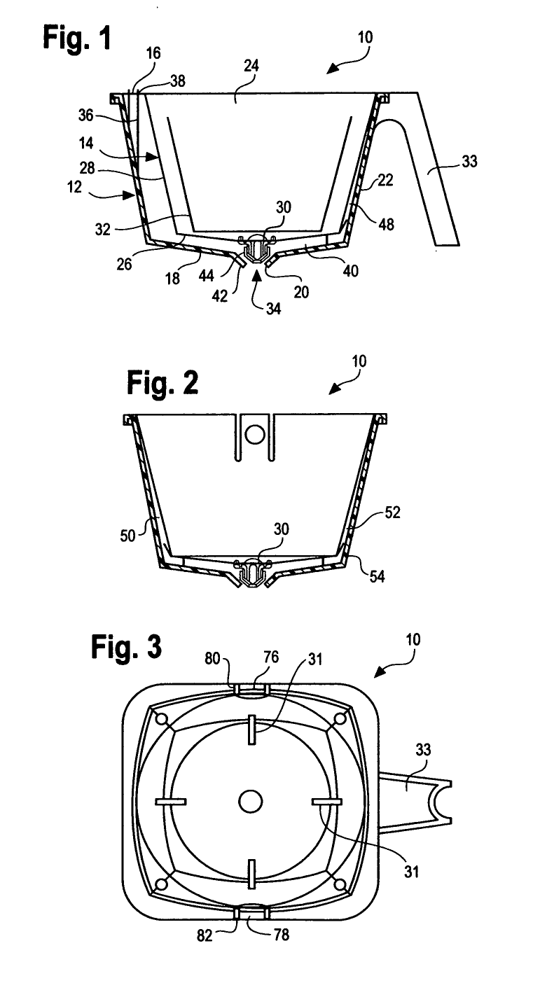

Referring now to FIGS. 1-3, an embodiment of the brew basket assembly 10 is seen to include an outer protective basket 12 and an inner basket 14. The outer protective basket has an open top 16, a bottom 18 with an open outlet 20 spaced from the open top 16 and a sidewall 22 extending between the open top 16 and the bottom 18. The inner basket 14 has an open top 24, an inner bottom 26 spaced from the inner open top 24 and an inner wall 28 extending between the inner top 24 and the inner bottom 26. The inner basket 14 is nestled within the outer protective basket 12 and has a drain hole 30 located opposite the open outlet 20. A removable wire brew basket 32 is supported by four support members 31 at the inside surface of the inner bottom 26. A flow valve 34 is protectively mounted to the inner basket 14 between the open outlet 20 and the drain hole 30 for selectively restricting the drain hole 30 to control a rate of flow of beverage though the drain hole 30 and the open outlet 20. A handle 33 is attached to the sidewall, or side, 22 of the outer basket 12.

Preferably, outer protective basket 12 is made from an insulating material, such as plastic material like polypropylene that is suitable for use with hot beverages. Also, preferably the inner basket is made from metal, such as stainless steel. A rearward bypass gap 36 is created between the rearward part of the side wall 28 of the inner basket 14 and the rearward part of the sidewall 22 of the outer protective basket 12. The rearward bypass gap 36 has an upwardly directed face 38 between the rearward edge of the open top 16 of the outer protective basket 12 and the rearward edges of the inner open top 24 of the inner basket 14 for receipt of bypass water. The bypass gap 36 extends downwardly from the open tops 16 and 22 to the inner bottom 26. The inner bottom 18 of the inner basket 12 is supported above an interior portion of the bottom 18 of the outer basket 12 to form a bottom gap 40 that communicates with the bypass gap 36. Bypass water that enters the face 38 of the bypass gap 36 passes down the bypass gap 36 and flows along the downwardly, inwardly slanted bottom through the bottom gap 40 to drain past the flow valve 34 and out the open outlet 20. The bottom 18 has a downwardly, inwardly extending, conical, funnel 42 surrounding the open outlet 20.

The flow valve 34 is partly within the bottom gap 40 and partly protectively nestled within the funnel 42 but is laterally spaced from the walls of the funnel 42 to provide a lateral gap 44 through which the bypass water flows from the bottom gap 40 to the open outlet 20. A forward air gap 48, a left side air gap 50 and a right side air gap 52 between the side walls of the inner basket 14 and the outer basket are also provided.

The bottom 26 is partly supported above the bottom 18 by a generally U-shaped peripheral support member 54 resting on and extending upwardly from the bottom 18 of the outer protective basket 12 adjacent the forward, left side and right side parts of the sidewall 22. There is no underlying support at the rearward part of the bottom 18 and the bottom 26 of the inner basket 14 is there suspended above the bottom 18 between the support member 54 at the sides. Preferably, the support member 54 is made from insulating material, and is preferably integrally molded together with the outer protective basket 12.

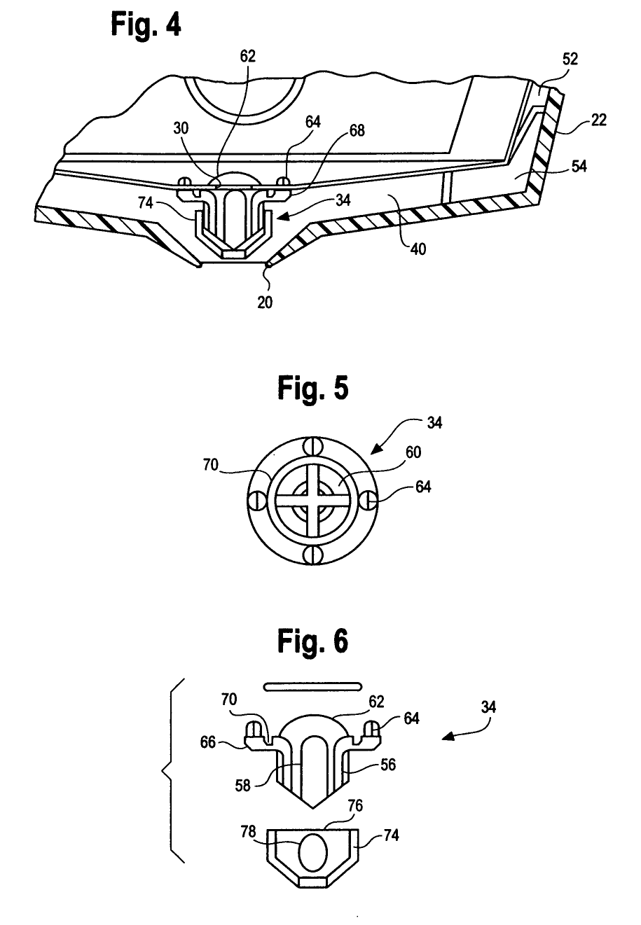

Now, referring to FIGS. 4-6, the brew basket assembly 10 the flow valve 34 has a generally circular cross section with a cylindrical body 56. The cylindrical body has a plurality of laterally facing, outlet drain openings 58 beneath the inner basket 14 that are in fluid communication with an upwardly facing inlet opening 60 that is within the inner basket. The inlet opening is at the top of a dome 62 that is received through the round drain hole 30 in the inner basket 14 from beneath the bottom 26 and fills the drain hole 30. The dome 62 is held within the drain hole by means of four, substantially identical, resilient snap fasteners 64 carried by an annular mounting collar 66. The snap fasteners 64 are pushed through four mating, mounting holes 68 surrounding the drain hole 30 while in a relatively compressed state and then expand to a locking configuration once fully inserted to prevent removal of the dome 62 from within the drain hole 30. The collar also has an upwardly facing annular groove 70 within which is seated an annular O-ring seal 72. The O-ring seal is pressed against the bottom surrounding the drain hole 30 when the dome 62 is fully inserted and locked in place to provide a water tight seal between the exterior of the body of the flow valve 34.

A rotatably mounted, resilient, adjustment member 74 has a cylindrical side wall 76 that resiliently fits over the cylindrical body 56 for relative rotary movement. Relative rotary movement of the adjustment member 74 selectively restricts the fluid passageway of the valve 34 to vary the drain flow rate of beverage through the flow valve 34. The side wall has a plurality of side outlet openings 78 which when selectively aligned with the side outlet openings 58 allows the beverage to drain through the outlet openings 78. When only the side wall 74 is aligned with outlet opening 58 then passage of beverage through the openings 58 is partly blocked.

Preferably, the relative dimensions of the outlet openings 58 and 78 and the spaces between adjacent openings is arranged to prevent complete blockage of all the openings 58 regardless of the relative rotary position of the valve adjustment member 74. This insures that when beverage is present in the brew basket assembly 10 there will always be at least some small amount draining of the beverage. This slight draining of beverage in such a situation will give a clear indication to the user that potentially scolding hot beverage is contained within the brew basket assembly 10. Such a warning is needed to prevent inadvertent injury when the brew basket is being removed from the brewer to make sure that a user realizes that the brew basket is not yet fully empty and will take the necessary precautions.

The inner basket 14 is releasably attached to the outer basket 12, and may be removed to access and rotate the adjustment member 74 to the desired relative position or drain rate setting. However, preferably the rotatably mounted adjustment member 74 is accessible through the open outlet 20 for manual engagement.

The releasable attaching means preferably includes mating snap fasteners adapted for mating resilient, releasable locking engagement automatically when the inner basket 14 is operatively inserted into the outer protective basket 12. As best seen, the snap fasteners preferably include a pair of opposed pins 76 and 78 carried by one of the outer protective basket 12 and the inner basket 14 and a pair of opposed female connector receptacles, or connector holes, 80 and 82 adapted for respective mating connection with the opposed pins 76 and 78, respectively. The pins 76 and 78 are preferably carried by the flexible outer basket 12 and the pin receptacles are carried by the inner stainless steel basket 14 The inwardly facing ends of the pins 76 and 78 are preferably rounded to facilitate sliding movement into the connector holes 80 and 82. The pins 76 and 78 are preferably integrally formed with together with the molded outer basket 12.

In accordance the present invention, a method of brewing beverage in a drip-type, electric beverage brewer that employs the beverage assembly of the present invention is provided. This method is achieved by performing the steps of (1) releasably mounting an inner basket within an outer protective basket to form a brew basket assembly with an insulating air gap between the inner basket and the outer protective basket, (2) placing beverage ingredient within the inner basket, and (3) passing water from the source of hot water through the ingredient within the inner basket while insulating the outer protective basket from heat from the inner basket with the air gap. Preferably, inner basket is made from beverage impervious and structurally rigid metal and the outer basket is made from a relatively flexible, thermal insulating material, the method includes the step of insulating the heat from the inner brew basket with the thermal insulating material of the outer basket. If the there is a manually adjustable drain valve carried by the inner basket as described above, the method includes the step of adjusting the drain valve to a selected drain rate that is appropriate for the beverage being brewed. More specifically, the step of adjusting the drain rate includes adjusting the drain valve to a relatively high rate when coffee is being brewed and adjusting the drain rate to a relatively lower rate when tea is being brewed. The method also includes the step of automatically resiliently, releasably attaching the inner basket to the outer protective basket after the drain valve has been adjusted.

The invention also contemplates a method of brewing beverage in a drip-type, electric beverage brewer, by performance of the steps of (1) adjusting a valve mounted within a drain hole of a brew basket assembly to a set a flow rate of beverage from the brew basket during performance of a brew cycle, (2) placing beverage ingredient within the brew basket, (3) dispensing water from a source of hot water through the ingredient within the brew basket, (4) passing beverage out of the brew basket through the valve at a flow rate determined during the step of adjusting, and (5) insulating the beverage within the brew basket with a nonmetallic, insulating material from which the brew basket assembly is at least partly made before the beverage passes through the rotary drain valve. Preferably, the step of insulating includes the step of insulating an inner metallic brew basket with an outer insulating brew basket with which the inner brew basket is contained. Preferably, included are one or more of the steps of (a) protecting the valve within a gap between the inner brew basket and the outer protective brew basket, (b) insulating the beverage within the brew basket with an air gap between the inner basket and the outer basket, (c) passing by-pass water through the outer basket without passing through the inner basket.

The method also preferably includes the steps of completing a brew cycle, placing a different beverage ingredient in the brew basket, readjusting the valve to a different setting associated with the different beverage ingredient, and performing another brew cycle with beverage passing out of the brew basket at a flow rate determined during the step of readjusting. Preferably, the step of adjusting is performed by manually rotating an adjustment member of the valve from without brew basket, and the step of passing includes passing the beverage though a passageway extending in sealed relationship through a drain hole in the basket between an inlet within the brew basket and an outlet outside the basket.

While a particular embodiment has been disclosed in detail, it should be appreciated that many changes may be made without departing from the scope of the invention. For instance, while preferably the outer basket 12 is made of stainless steel, it could also be made of other metal or of an insulating material. Likewise, although the inner basket 14 is preferably made of insulating material such as polypropylene plastic, it could be made of stainless steel or the like. If the outer basket 12 is made of steel, then it may be desired to provide it with a double-walled construction with an insulating evacuated gap, air gap, gap filled within insulation or an insulating coating on either or both of the interior and exterior surfaces. Thus, both baskets may be metal or both baskets may be made from plastic. While particular shapes have been indicated, other shapes could work as well. Other obvious variations will occur to those skilled in the art.

1. A brew basket assembly, comprising:
an outer protective basket with an open top, a bottom with an open outlet spaced from the open top and a sidewall extending between the open top and the bottom;
an inner basket with an inner open top, a inner bottom spaced from the inner open top and an inner wall extending between the inner top and the inner bottom, said inner basket being nestled within the outer protective basket and having a drain hole located opposite the open outlet;
means for supporting a filter holder within the inner basket; and
a flow valve protectively mounted to the inner basket between the open outlet and the drain hole for selectively restricting the drain hole to control a rate of flow of beverage though the drain hole and the open outlet.

2. The brew basket assembly of claim 1 in which the outer protective basket is made from an insulating material.

3. The brew basket assembly of claim 2 in which the insulating material is plastic material.

4. The brew basket assembly of claim 1 in which the inner basket is made from metal.

5. The brew basket assembly of claim 4 in which the metal is stainless steel.

6. The brew basket of claim 4 in which the outer basket is made of insulating material.

7. The brew basket assembly of claim 6 in which the insulating material is plastic material.

8. The brew basket assembly of claim 1 in which there is an air gap between the inner wall of the inner basket and the sidewall of the outer protective basket.

9. The brew basket assembly of claim 1 including a gap between the open top of the outer protective basket and the inner open top of the inner basket for receipt of bypass water.

10. The brew basket assembly of claim 9 in which the gap extends from the inner open top to the inner bottom.

11. The brew basket assembly of claim 1 including means for supporting the inner bottom of the inner basket above an interior portion of the bottom of the outer basket to form a bottom gap.

12. The brew basket assembly of claim 11 in which the support means includes a peripheral support member resting on the bottom of the outer protective basket adjacent the sidewall.

13. The brew basket of claim 12 in which the support member is made from insulating material.

14. The brew basket assembly of claim 13 in which the support member is an integral part of the outer protective basket.

15. The brew basket assembly of claim 11 in which the flow valve is at least partly located in the bottom gap.

16. The brew basket assembly of claim 1 in which the flow valve has a generally cylindrical body with a fluid passageway providing fluid communication from within the inner basket to without the inner basket through the drain hole and an adjustment member mounted to the cylindrical body for relative rotary movement to selectively restrict the fluid passageway to vary flow rate of beverage through the passageway.

17. The brew basket assembly of claim 16 in which the rotatably mounted adjustment member is accessible through the open outlet for manual engagement.

18. The brew basket assembly of claim 1 including means for releasably attaching the inner basket to the outer protective basket.

19. The brew basket assembly of claim 18 in which the attaching means include a pair of opposed pins carried by one of the outer protective basket and the inner basket and a pair of opposed female connectors adapted for respective mating connection with the opposed pins.

20. The brew basket assembly of claim 19 including two opposed pairs of parallel slots in the sidewall adjacent the open top respectively forming two opposed resilient mounting tongues and including means for mounting one of the pair of pins and the pair of mating female pin connectors to each of the opposed mounting tongues.

21. The brew basket of claim 1 including a snap fastener integrally formed with one of the protective outer basket and the inner basket.

22. The brew basket of claim 21 including a mating snap fastener adapted for mating resilient, releasable locking engagement with the one snap fastener automatically when the inner basket is operatively inserted into the outer protective basket.

23. A brew basket assembly with an interior for holding beverage ingredient during the passage of water through the brew basket of an electric, drip-type, beverage brewer, comprising:
a basket with an open top, a bottom spaced from the open top, a wall extending between the top and the bottom and a drain hole in the bottom;
a filter holder mounted within the basket; and
a continuous flow rate adjustable, valve assembly mounted within the drain hole and having a movably mounted, manual adjustment member for manually selectively adjusting the flow rate of beverage through the flow valve and the drain hole during a brew cycle.

24. The brew basket assembly of claim 23 in which the valve assembly includes
a valve body with a passageway extending between an inlet within the basket and an outlet located without the basket,
means for fastening the valve body within the drain hole, and
means for mounting the adjustment member to the valve body for relative rotary movement to selectively adjust the flow rate of beverage through the valve body.

25. The brew basket assembly of claim 24 in which the rotatably mounted adjustment member is accessible for manual engagement from without brew basket.

26. The brew basket assembly of claim 24 in which the valve body is fixedly attached to the drain hole in fluid sealed relationship.

27. The brew basket assembly of claim 23 including an outer basket assembly within which the basket is received and supported with an open outlet located beneath the drain hole and the valve assembly.

28. The brew basket assembly of claim 27 in which at least part of the valve is protectively contained in a gap between the basket and the outer basket assembly.

29. The brew basket assembly of claim 27 in which the basket has a releasable connector element and the outer basket assembly has a mating connector that releasably attaches to the releasable connector when the basket is inserted into the outer basket assembly.

30. The brew basket assembly of claim 27 in which the
basket is made of metal, and
the outer basket assembly is made of plastic.
